(19) United States
(12) Patent Application Publication
(10) Pub. No.: US 2016/0182786 A1
(43) Pub. Date: Jun. 23, 2016

(54) HYBRID LIGHT-FIELD CAMERA

(71) Applicant: Lytro, Inc., Mountain View, CA (US)

(72) Inventors: David Anderson, Wellesely, MA (US); Todd Roesler, Greyslake, IL (US); William D. Houck, II, Fremont, CA (US); Ravi Kiran Nalla, San Jose, CA (US); Steven David Oliver, San Jose, CA (US)

(21) Appl. No.: 15/054,030

(22) Filed: Feb. 25, 2016

Related U.S. Application Data
(63) Continuation-in-part of application No. 14/716,055, filed on May 19, 2015.
Application No. 14/716,055 is a continuation of application No. 14/480,240, filed on Sep. 8, 2014, now Pat. No. 9,077,901.
(60) Provisional application No. 61/876,377, filed on Sep. 11, 2013.

(51) Int. Cl. H04N 5/225; G02B 7/02; G02B 3/00; H04N 5/232

(52) U.S. Cl. CPC H04N 5/2254; H04N 5/23245; H04N 5/2253; G02B 7/023; G02B 3/0006

(57) ABSTRACT

A light-field camera may have a light-field capture configuration in which the light-field camera captures light-field images, and a conventional capture configuration in which the light-field camera captures conventional images. User input may be received; in response to receipt of the user input, the light-field camera may move from an initial configuration in which the light-field camera is in one of the light-field capture configuration, and the conventional capture configuration, to a selected configuration in which the light-field camera is in the other of the light-field capture configuration, and the conventional capture configuration. The light-field camera may be used to capture a first image in the selected configuration. The light-field camera may have a sensor, a microlens array, an actuator, and a guide mechanism by which the microlens array may be moved relative to the sensor to move the light-field camera into the selected configuration.

### CROSS-REFERENCE TO RELATED APPLICATIONS

The present application claims priority as a continuation-in-part of U.S. Utility application Ser. No. 14/716,055 for “Light Field Image Capture Device Having 2D Image Capture Mode” (Atty. Docket No. LYT140-CONT), filed on May 19, 2015, which claimed priority as a continuation of U.S. Utility application Ser. No. 14/480,240 for “Light Field Image Capture Device Having 2D Image Capture Mode” (Atty. Docket No. LYT140), filed on Sep. 8, 2014, issued on Jul. 7, 2015 as U.S. Pat. No. 9,077,901, which claimed priority from U.S. Provisional Application Ser. No. 61/876,377 for “Moving, Enabling, and Disabling Microlens Array in Light Field Capture Device” (Atty. Docket No. LYT140-PROV), filed on Sep. 11, 2013. All of these applications are incorporated herein by reference.

### TECHNICAL FIELD

The present disclosure relates to digital imaging systems and methods, and more specifically, to systems and methods for capturing light-field and conventional images with a single camera.

### BACKGROUND

In conventional photography, the camera must typically be focused at the time the photograph is taken. The resulting image may only have color data for each pixel; accordingly, any object that was not in focus when the photograph was taken cannot be brought into sharper focus because the necessary data does not reside in the image. Further, conventional images typically contain little or no depth information to indicate the distance between the imaging plane and the objects in the scene.

By contrast, light-field images can be modified through the use of a wide variety of post-processing techniques to adjust and/or enhance depth-of-field, thereby permitting the user to refocus the image as desired. Further, a light-field image can be used to derive depth information regarding the image. The depth information can enable a wide variety of other post-processing techniques and algorithms. However, light-field images typically require a larger amount of storage space, and in some instances, may require more significant post-processing steps to provide the image desired by the user.

Unfortunately, existing cameras generally are capable of capturing only conventional images, or only light-field images. Thus, a user wishing to capture conventional and light-field images must use multiple cameras. The cameras must be independently configured; accordingly, the user may not easily transition from one type of imaging to the other.

### SUMMARY

According to various embodiments, the system and method described herein provide a light-field camera that can be used to capture both light-field images and conventional (e.g. two dimensional) images. In one embodiment, the light-field camera may initially be disposed in an initial configuration, in which the light-field camera is configured to capture either conventional images or light-field images. An image sensor of the light-field camera may capture one or more images in the initial configuration. An input device of the light-field camera may receive user input indicating whether a light-field image or a conventional image is to be captured. In response to receipt of the user input, the light-field camera may be moved from the initial configuration to a selected configuration in which the light-field camera is configured to capture images of the other type. One or more images of the selected type may then be captured with the image sensor of the light-field camera.

In at least one embodiment, the light-field camera may have an aperture, a main lens, and a microlens array. The sensor may be positioned proximate the microlens array to capture light after passage of the light through the main lens and the microlens array. Moving the light-field camera from the initial configuration to the selected configuration may include inducing relative motion between the microlens array and the sensor between a light-field displacement, at which the microlens array is displaced from the sensor to cause the light to define a light-field image, and a conventional displacement, at which the microlens array is positioned closer to the sensor to cause the light to define a conventional image. The light-field displacement may be about 38 μM, and the conventional displacement may be about 0 μM such that, in the conventional capture configuration, the microlens array is positioned to abut the sensor.

The light-field camera may have an actuation assembly with a guide mechanism and an actuator. Moving the light-field camera from the initial configuration to the selected configuration may include using the actuator to urge relative motion between the microlens array and the sensor to induce motion toward one of the light-field capture configuration and the conventional capture configuration. The guide mechanism may be used to guide the relative motion.

The actuator may include any of a wide variety of devices that can be used for linear actuation. The guide mechanism may be any device that can guide motion, with or without the inclusion of motion stops to ensure that the microlens assembly does not travel further than is needed, relative to the image sensor, to provide the light-field capture configuration and/or the conventional capture configuration.

For example, the actuator may include a plurality of permanent magnets. Moving the light-field camera from the initial configuration to the selected configuration may include moving the permanent magnets.

Additionally or alternatively, the actuator may include a piezo actuator. Moving the light-field camera from the initial configuration to the selected configuration may include altering voltage input to the piezo actuator to cause elongation or contraction of the piezo actuator. A mechanical amplifier may be included such that moving the light-field camera from the initial configuration to the selected configuration includes mechanically amplifying motion of the piezo actuator with the mechanical amplifier.

Additionally or alternatively, the actuator may include a solenoid that includes a coil and a core. Moving the light-field camera from the initial configuration to the selected configuration may include altering a flow of electric current through the coil to urge the core to move relative to the coil.

Additionally or alternatively, the actuator may include a moving coil type voice coil with a coil and a permanent magnet. Moving the light-field camera from the initial configuration to the selected configuration may include altering current flow through the coil to urge the coil to move relative to the permanent magnet.

Additionally or alternatively, the actuator may include a moving magnet type voice coil with a coil and a permanent magnet. Moving the light-field camera from the initial configuration to the selected configuration may include altering current flow through the coil to urge the permanent magnet to move relative to the coil.

Additionally or alternatively, the actuator may include a bimetallic strip with a first side formed of a first material having a first coefficient of thermal expansion and a second side formed of a second material having a second coefficient of thermal expansion less than the first coefficient of thermal expansion. Moving the light-field camera from the initial configuration to the selected configuration may include inducing heating the bimetallic strip to cause the first side to expand more than the second side, thereby urging a central portion of the first side to move relative to ends of the first side.

In some embodiments, the guide mechanism may include a flexure sheet secured to the sensor or the microlens array. Moving the light-field camera from the initial configuration to the selected configuration may include increasing or relieving flexure in the flexure sheet. Various other actuators and/or guide mechanisms can be used. In some embodiments, the actuation assembly may include an actuator that includes or is otherwise integrated with a guide mechanism.

The actuation assembly may allow the light-field camera to switch between light-field capture and conventional capture configurations. Thus, the user may relatively freely switch between capture of light-field images and capture of conventional images.

### BRIEF DESCRIPTION OF THE DRAWINGS

The accompanying drawings illustrate several embodiments. Together with the description, they serve to explain the principles of the embodiments. One skilled in the art will recognize that the particular embodiments illustrated in the drawings are merely exemplary, and are not intended to limit scope.

FIG. 1 depicts a portion of a light-field image.

FIG. 2 depicts an example of an architecture for implementing the methods of the present disclosure in a light-field capture device, according to one embodiment.

FIG. 3 depicts an example of an architecture for implementing the methods of the present disclosure in a post-processing system communicatively coupled to a light-field capture device, according to one embodiment.

FIG. 4 depicts an example of an architecture for a light-field camera for implementing the methods of the present disclosure according to one embodiment, with the microlens array and image sensor positioned at a light-field displacement.

FIG. 5 depicts the architecture of FIG. 4, with the microlens array and image sensor positioned at a conventional displacement.

FIG. 6 is a flow diagram depicting a method of moving the light-field camera between a light-field capture configuration and a conventional capture configuration, according to one embodiment.

FIGS. 7A and 7B are perspective views of a guide mechanism in the form of a blade type flexure sheet, in a rest configuration and a flexed configuration, respectively, according to one embodiment.

FIGS. 8A and 8B are perspective views of a guide mechanism in the form of a diaphragm type flexure sheet, in a rest configuration and a flexed configuration, respectively, according to one embodiment.

FIGS. 9A, 9B, and 9C are perspective views of an actuation assembly with actuators in the form of permanent magnets, in an exploded configuration, a fully-assembled, conventional capture configuration, and a fully-assembled, light-field capture configuration, respectively, according to one embodiment.

FIGS. 10A and 10B are perspective views of actuation assemblies with actuators in the form of piezo actuators and piezo actuators with a mechanical amplifiers, respectively, according to selected embodiments.

FIGS. 11A and 11B are side elevation views of an actuator in the form of a solenoid, with current flow to urge retraction of the solenoid, and with no current flow, according to one embodiment.

FIGS. 12A and 12B are perspective views of a moving coil voice coil actuator and a moving magnet voice coil actuator, according to selected embodiments.

FIGS. 12C and 12D are perspective and section views, respectively, of an actuation assembly with actuators in the form of moving magnet voice coil actuators as in FIG. 12B, according to one embodiment.

FIGS. 13A and 13B are perspective views of an actuation assembly with actuators in the form of blade type bimetallic strips and an actuation assembly with actuators in the form diaphragm type bimetallic strips, respectively, according to selected embodiments.

### DEFINITIONS

For purposes of the description provided herein, the following definitions are used:
Actuation assembly: an assembly in which components can be actuated relative to each other.
Actuator: a component that provides force tending to induce relative motion between other components.
Conventional capture configuration: a configuration of a camera in which the camera is able to capture conventional images.
Conventional image: an image in which the pixel values are not, collectively or individually, indicative of the angle of incidence at which light is received by a camera.
Depth: a representation of distance between an object and/or corresponding image sample and a microlens array of a camera.
Disk: a region in a light-field image that is illuminated by light passing through a single microlens; may be circular or any other suitable shape.
Extended depth of field (EDOF) image: an image that has been processed to have objects in focus along a greater depth range.
Guide mechanism: a mechanism that guides the relative motion between components.
Image: a two-dimensional array of pixel values, or pixels, each specifying a color.
Initial configuration: a configuration of a camera prior to receipt of user input.
Input device: any device that receives input from a user.
Light-field camera: any camera capable of capturing light-field images.
Light-field capture configuration: a configuration of a camera in which the camera is able to capture light-field images.
Light-field data: data indicative of the angle of incidence at which light is received by a camera.
Light-field image: an image that contains a representation of light-field data captured at the sensor.
Microlens: a small lens, typically one in an array of similar microlenses.
Microlens array: an array of microlenses arranged in a predetermined pattern.
Selected configuration: a configuration of a camera after reconfiguration in accordance with user input.
Sensor, or “image sensor”: a light detector in a camera capable of generating images based on light received by the sensor.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

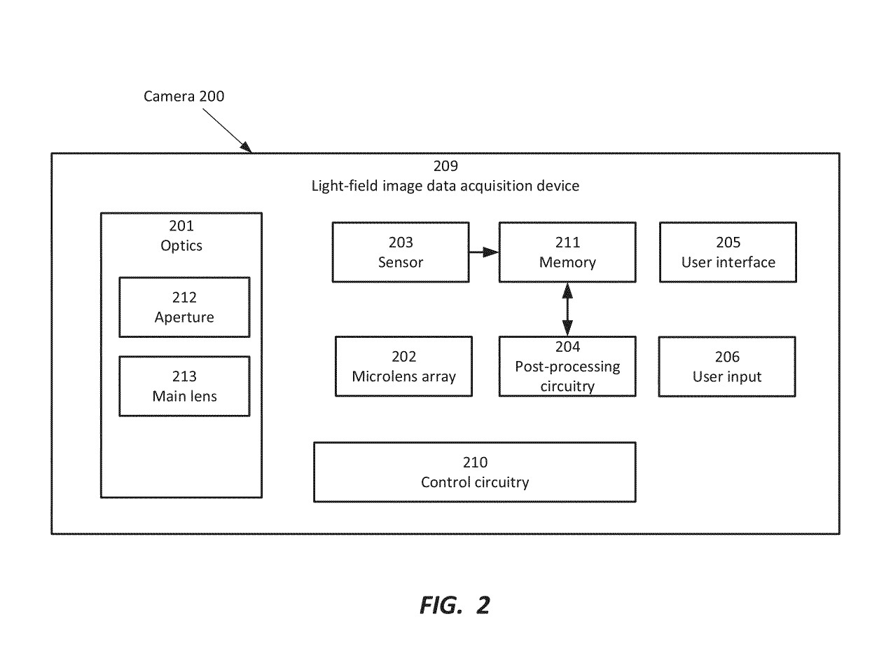

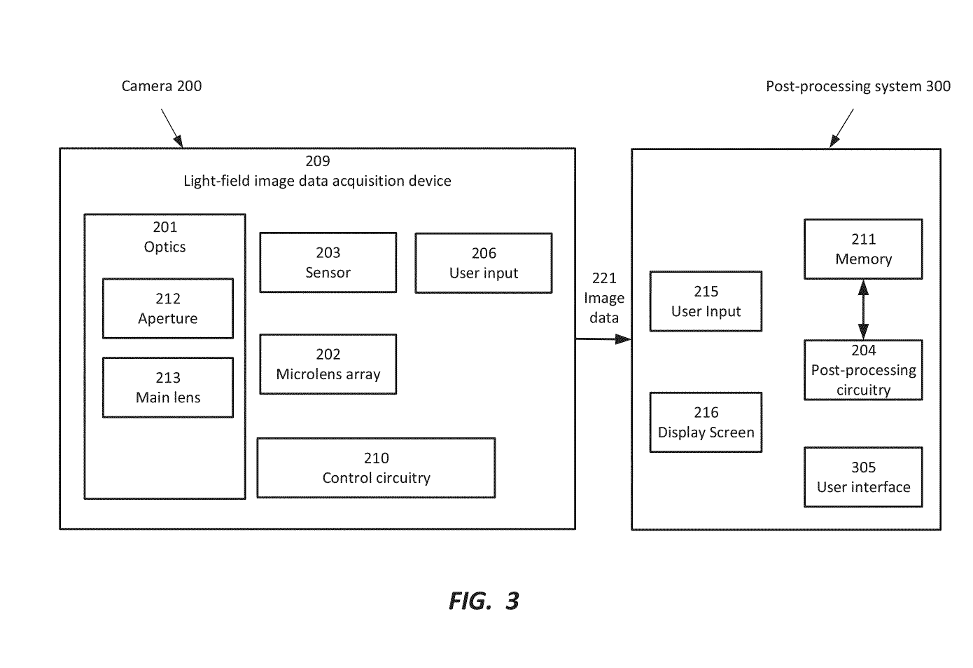

In at least one embodiment, the system and method described herein can be implemented in connection with light-field images captured by light-field capture devices including but not limited to those described in Ng et al., Light-field photography with a hand-held plenoptic capture device, Technical Report CSTR 2005 February, Stanford Computer Science. Referring now to FIG. 2, there is shown a block diagram depicting an architecture for implementing the method of the present disclosure in a light-field capture device such as a camera 200. Referring now also to FIG. 3, there is shown a block diagram depicting an architecture for implementing the method of the present disclosure in a post-processing system 300 communicatively coupled to a light-field capture device such as a camera 200, according to one embodiment. One skilled in the art will recognize that the particular configurations shown in FIGS. 2 and 3 are merely exemplary, and that other architectures are possible for camera 200. One skilled in the art will further recognize that several of the components shown in the configurations of FIGS. 2 and 3 are optional, and may be omitted or reconfigured.

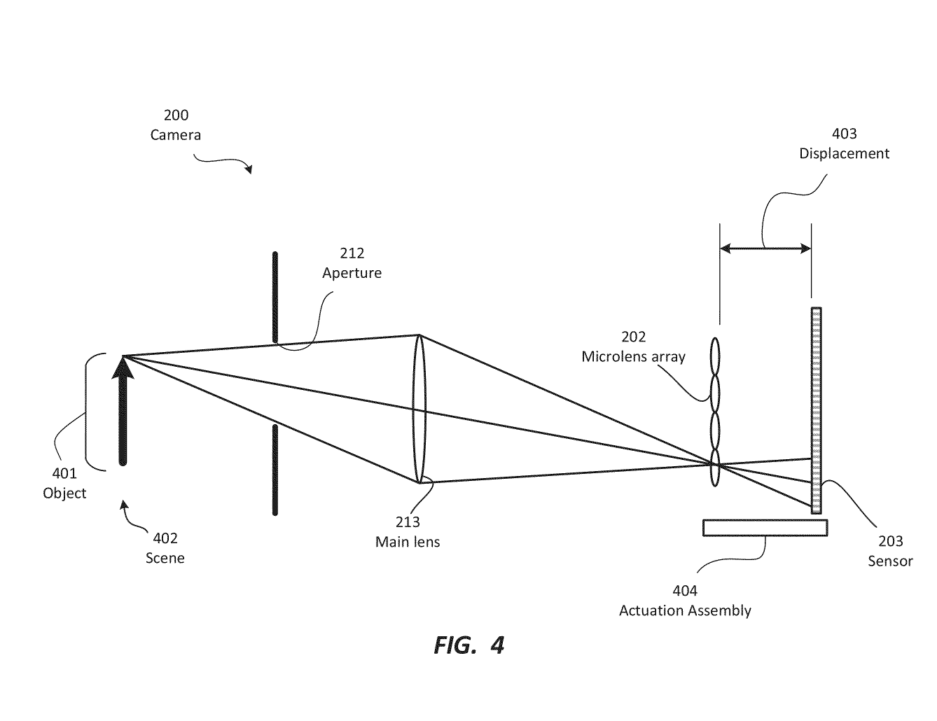

In at least one embodiment, camera 200 may be a light-field camera that includes light-field image data acquisition device 209 having optics 201, image sensor 203 (including a plurality of individual sensors for capturing pixels), and microlens array 202. Optics 201 may include, for example, aperture 212 for allowing a selectable amount of light into camera 200, and main lens 213 for focusing light toward microlens array 202. In at least one embodiment, microlens array 202 may be disposed and/or incorporated in the optical path of camera 200 (between main lens 213 and image sensor 203) so as to facilitate acquisition, capture, sampling of, recording, and/or obtaining light-field image data via image sensor 203. Referring now also to FIG. 4, there is shown an example of an architecture for a light-field camera, or camera 200, for implementing the method of the present disclosure according to one embodiment. The Figure is not shown to scale. FIG. 4 shows, in conceptual form, the relationship between aperture 212, main lens 213, microlens array 202, and image sensor 203, as such components interact to capture light-field data for one or more objects, represented by an object 401, which may be part of a scene 402.

In at least one embodiment, camera 200 may also include a user interface 205 for allowing a user to provide input for controlling the operation of camera 200 for capturing, acquiring, storing, and/or processing image data. The user interface 205 may receive user input from the user via an input device 206, which may include any one or more user input mechanisms known in the art. For example, the input device 206 may include one or more buttons, switches, touch screens, gesture interpretation devices, pointing devices, and/or the like.

Similarly, in at least one embodiment, post-processing system 300 may include a user interface 305 that allows the user to provide input to switch image capture modes, as will be set forth subsequently. The user interface 305 may additionally or alternatively facilitate the receipt of user input from the user to establish one or more other image capture parameters.

In at least one embodiment, camera 200 may also include control circuitry 210 for facilitating acquisition, sampling, recording, and/or obtaining light-field image data. The control circuitry 210 may, in particular, be used to switch image capture configurations in response to receipt of the corresponding user input. For example, control circuitry 210 may manage and/or control (automatically or in response to user input) the acquisition timing, rate of acquisition, sampling, capturing, recording, and/or obtaining of light-field image data.

In at least one embodiment, camera 200 may include memory 211 for storing image data, such as output by image sensor 203. Such memory 211 can include external and/or internal memory. In at least one embodiment, memory 211 can be provided at a separate device and/or location from camera 200.

For example, when camera 200 is in a light-field image capture configuration, camera 200 may store raw light-field image data, as output by image sensor 203, and/or a representation thereof, such as a compressed image data file. In addition, when camera 200 is in a conventional image capture configuration, camera 200 may store conventional image data, which may also be stored as raw, processed, and/or compressed output by the image sensor 203.

In at least one embodiment, captured image data is provided to post-processing circuitry 204. The post-processing circuitry 204 may be disposed in or integrated into light-field image data acquisition device 209, as shown in FIG. 2, or it may be in a separate component external to light-field image data acquisition device 209, as shown in FIG. 3. Such separate component may be local or remote with respect to light-field image data acquisition device 209. Any suitable wired or wireless protocol can be used for transmitting image data 221 to circuitry 204; for example, the camera 200 can transmit image data 221 and/or other data via the Internet, a cellular data network, a Wi-Fi network, a Bluetooth communication protocol, and/or any other suitable means.

Such a separate component may include any of a wide variety of computing devices, including but not limited to computers, smartphones, tablets, cameras, and/or any other device that processes digital information. Such a separate component may include additional features such as a user input 215 and/or a display screen 216. If desired, light-field image data may be displayed for the user on the display screen 216.

### Overview

Light-field images often include a plurality of projections (which may be circular or of other shapes) of aperture 212 of camera 200, each projection taken from a different vantage point on the camera's focal plane. The light-field image may be captured on image sensor 203. The interposition of microlens array 202 between main lens 213 and image sensor 203 causes images of aperture 212 to be formed on image sensor 203, each microlens in microlens array 202 projecting a small image of main-lens aperture 212 onto image sensor 203. These aperture-shaped projections are referred to herein as disks, although they need not be circular in shape. The term “disk” is not intended to be limited to a circular region, but can refer to a region of any shape.

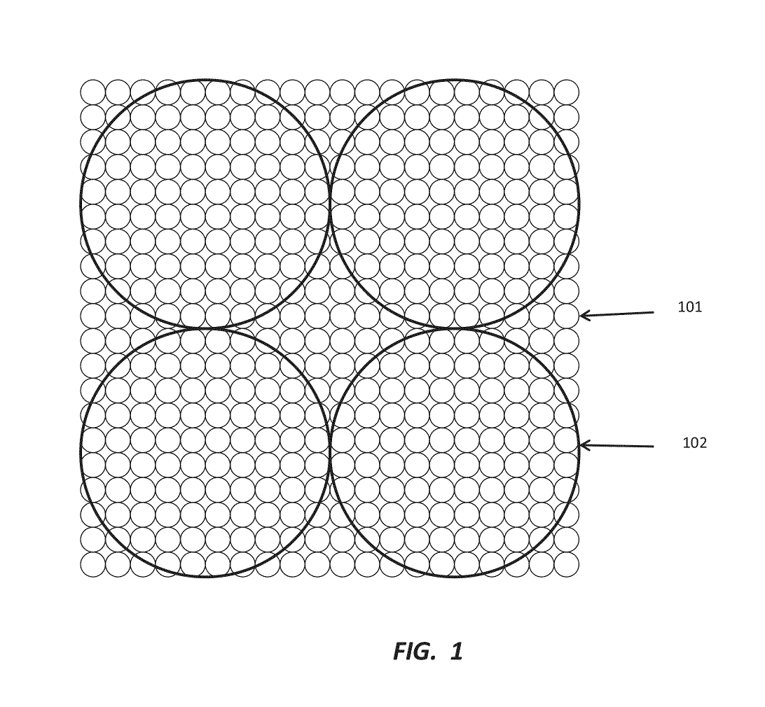

Light-field images include four dimensions of information describing light rays impinging on the focal plane of camera 200 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 1, there is shown an example of a 2-disk by 2-disk portion of such a light-field image, including depictions of disks 102 and individual pixels 101; for illustrative purposes, each disk 102 is ten pixels 101 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position During Light-Field Image Processing,” (Atty. Docket No. LYT021), filed Feb. 22, 2013, the disclosure of which is incorporated herein by reference in its entirety, a virtual surface of projection may be introduced, and the intersections of representative rays with the virtual surface can be computed. The color of each representative ray may be taken to be equal to the color of its corresponding pixel.

### Light-Field and Conventional Capture Configurations

Referring again to FIG. 4, a camera 200 according to the present disclosure may be made to operate in different configurations, depending on whether light-field images or conventional images are to be captured. In some embodiments this may be done through software alone (for example, by collapsing or eliminating light-field data in the event that a conventional image is to be captured). However, in some embodiments, it may be beneficial to enable the camera 200 to dedicate the entire resolution of the image sensor 203 to capture of conventional images. Thus, in order to move the camera 200 from a light-filed capture configuration to a conventional capture configuration, the optical pathways of the camera 200 may be reconfigured to facilitate capture of conventional images.

According to selected embodiments, this may be accomplished by adjusting a displacement 403 between the microlens array 202 and the image sensor 203. The displacement 403 illustrated in FIG. 4 may be suitable for capture of light-field images because the displacement 403 is sufficient to permit the light received through each microlens of the microlens array 202 to spread to its associated region of the image sensor 203. Thus, the angle of incidence of the light received by the camera 200 may be encoded in the light-field image, as described above and in the publications referenced previously. Accordingly, the displacement 403 may be a light-field displacement.

In some embodiments, the displacement 403 may be between 10 μM and 100 μM. More specifically, the displacement 403 may be between 20 μM and 75 μM. Yet more specifically, the displacement 403 may be between 30 μM and 50 μM. Still more specifically, the displacement 403 may be about 38 μM.

Moving the microlens array 202 closer to the image sensor 203 may reduce the displacement between the microlens array 202 and the image sensor 203 below the displacement 403. This may be accomplished, for example, through the use of an actuation assembly 404, which may be mechanically coupled to the microlens array 202 and to the image sensor 203 such that the actuation assembly 404 is able to induce relative motion between the image sensor 203 and the actuation assembly 404.

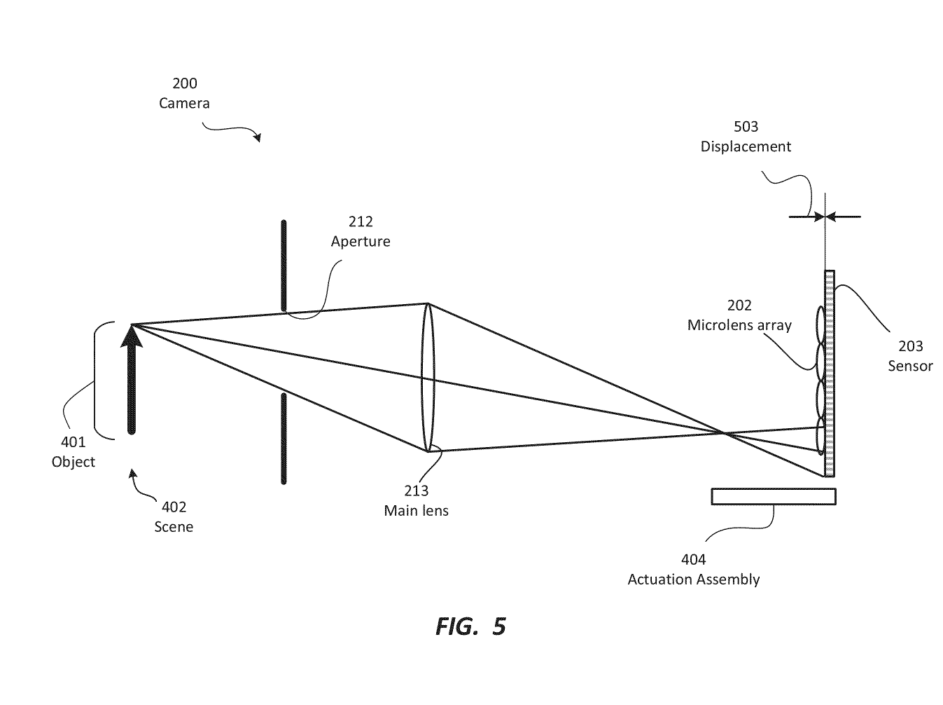

Moving the microlens array 202 closer to the image sensor 203 may effectively reduce the amount of light-field data captured by the image sensor 203. Moving the microlens array 202 into abutment with the image sensor 203 may cause this displacement value to be approximately zero. The result may be that little or no light-field data is captured by the image sensor 203. The resulting configuration is shown in FIG. 5.

FIG. 5 depicts the architecture of FIG. 4, with the microlens array 202 and image sensor 203 positioned at a displacement 503 suitable for capture of conventional images. Thus, the displacement 503 may be a “conventional displacement.” As shown, the displacement 503 may be substantially zero, indicating that the adjacent surfaces of the microlens array 202 and the image sensor 203 are positioned in contact, or nearly in contact, with each other. Notably, this may be accomplished by moving either the microlens array 202 or the image sensor 203 while holding the other stationary. FIG. 5 illustrates, by way of example, in that the microlens array 202 has moved closer to the image sensor 203.

Notably, some of the light captured by the camera 200 may, in the configuration of FIG. 5, bypass the microlens array 202 on its way to the image sensor 203. Due to the proximity between the microlens array 202 and the image sensor 203, it may make little difference whether the light passes through the microlens array 202 before being captured by the image sensor 203. If desired, the microlens array 202 may be made sufficiently large that light must pass through it before reaching the image sensor 203, even in the conventional capture configuration.

Motion of the camera 200 from the light-field capture configuration of FIG. 4 to the conventional capture configuration of FIG. 5 may be accomplished via the actuation assembly 404 as described previously. Further, the actuation assembly 404 may be used to move the camera 200 from the conventional capture configuration of FIG. 5 to the light-field capture configuration of FIG. 4. The actuation assembly 404 may be connected to the input device 206 of FIGS. 2 and/or 3. The user may use the input device 206 to select between the light-field capture configuration and the conventional capture configuration, and provide the corresponding user input, in any of a wide variety of ways, depending on the type of device(s) present in the input device 206.

Additionally or alternatively, the camera 200 may automatically move between the light-field image capture configuration and the conventional image capture configuration, without requiring explicit user input. Such automatic reconfiguration may be based on any one or more factors, which may be automatically assessed by the camera 200. Such factors may include, but are not limited to, the range of depth present in the scene, the intensity of light being received by the image sensor, the amount of storage space left in the memory 211 of the camera 200, and/or the like.

Notably, moving the camera 200 into the conventional capture configuration may entail altering other aspects of the optical pathway of the camera 200. For example, light-field images may not require the camera 200 to be focused prior to capture. Rather, the main lens 213 may be stationary with respect to other components of the camera 200, such as the aperture 212, the microlens array 202, and/or the image sensor 203. Any focusing may be carried out via post-processing, through the use of the light-field data captured by the camera 200. However, it may be beneficial to permit adjustment of the location of the main lens 213 relative to one or more components of the camera 200 prior to capture of a conventional image, in order to ensure that the conventional image is properly focused, since a conventional image cannot generally be refocused during post-processing steps.

Thus, it may be desirable to unlock a focusing function when the camera 200 is moved into the conventional capture configuration, and to lock the focusing function when the camera is moved into the light-field capture configuration. Unlocking the focusing function may, for example, entail unlocking motion of the main lens 213 relative to other components of the camera 200, as described previously. This motion may again be locked when the camera 200 is moved back to the light-field capture configuration.

FIGS. 4 and 5 represent only one embodiment of a camera that may be used to practice the system and method of the invention. The camera 200 is a light-field camera with the microlens array 202 positioned to enable the image sensor 203 to gather light-field data. However, in alternative embodiments, different camera types may be used. In some embodiments, a stereoscopic camera, multiscopic camera, or the like may be used. Various software-based and/or mechanical systems may be used to selectively eliminate stereoscopic or multiscopic data to capture a conventional image when desired by the user.

### Changing Camera Configurations

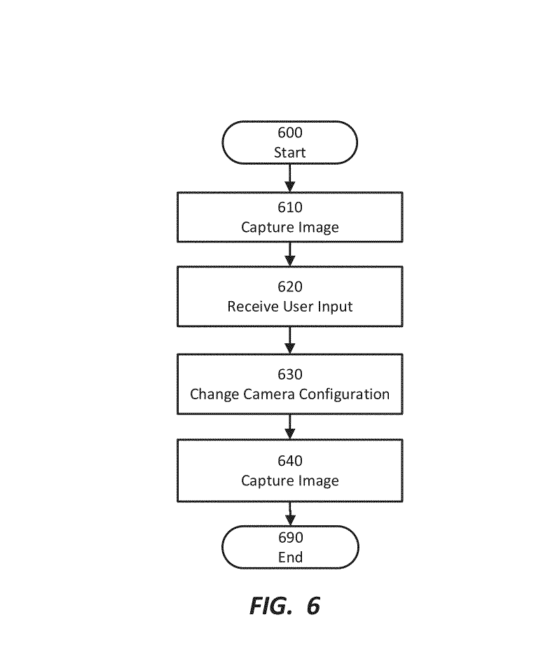

Referring to FIG. 6, a flow diagram depicts a method of moving the camera 200 between a light-field capture configuration and a conventional capture configuration, according to one embodiment. The method may be performed, for example, through the use of a camera 200 as illustrated in FIGS. 2 and/or 3. However, in alternative embodiments, a method according to the present disclosure may be performed through the use of hardware architecture different from that illustrated in FIGS. 2 and 3. Similarly, the hardware architecture of FIGS. 2 and 3 may be used to perform alternative methods besides that of FIG. 6, which may include alternative methods for moving the camera 200 between a light-field capture configuration and a conventional image capture configuration.

The method may start 600 with a step 610 in which an image is captured with the image sensor 203 of the camera 200, in an initial configuration. The initial configuration may be either the light-field capture configuration, such as that of FIG. 4, or the conventional capture configuration, such as that of FIG. 5. Thus, the image captured in the step 610 may be a light-field image or a conventional image, depending on the configuration of the camera 200 as the step 610 is carried out. The step 610 is optional.

In a step 620, user input may be received to change the configuration of the camera 200 from the light-field capture configuration to the conventional capture configuration, or from the conventional capture configuration to the light-field capture configuration. The user input may be received via the input device 206 and the user interface 205 of the camera 200. As indicated previously, the input device 206 may have any known configuration; thus, the user may provide the input, for example, by flipping a switch, rotating knob, pushing a button, tapping on a touch screen, pointing with a pointing device, or the like. Additionally or alternatively, the camera 200 may move between the light-field image capture configuration and the conventional image capture configuration automatically in response to evaluation of one or more factors, as described previously.

In a step 630, the camera 200 may move, in response to receipt of the user input or automatic evaluation of the factor(s) as described above, from the initial configuration to the selected configuration. As indicated previously, this may be done via software in some embodiments. However, this may also be done via manipulating the optical pathways within the camera 200 by moving the microlens array 202 relative to the image sensor 203 as described previously. Thus, moving the camera 200 from the initial configuration to the selected configuration may entail inducing relative motion between the microlens array 202 and the image sensor 203, for example, from the displacement 403 of FIG. 4 (the light-field displacement) to the displacement 503 of FIG. 5 (the conventional displacement), or from the displacement 503 to the displacement 403. Optionally, moving the camera 200 from the initial configuration to the selected configuration may also entail locking or unlocking a focusing function, as described previously.

In a step 640, another image may be captured with the image sensor 203 of the camera 200, in the selected configuration. The selected configuration may be either the light-field capture configuration or the conventional capture configuration (the opposite of the initial configuration), as illustrated in FIGS. 4 and 5. Thus, the image captured in the step 640 may be a light-field image or a conventional image, depending on the configuration of the camera 200 as the step 640 is carried out. The method may then end 690.

The method of FIG. 6 is only one of many possible methods that may be used to change the configuration of a light-field camera according to the present disclosure. According to various alternatives, various steps of FIG. 6 may be carried out in a different order, omitted, and/or replaced by other steps.

### Exemplary Actuation Assembly Components

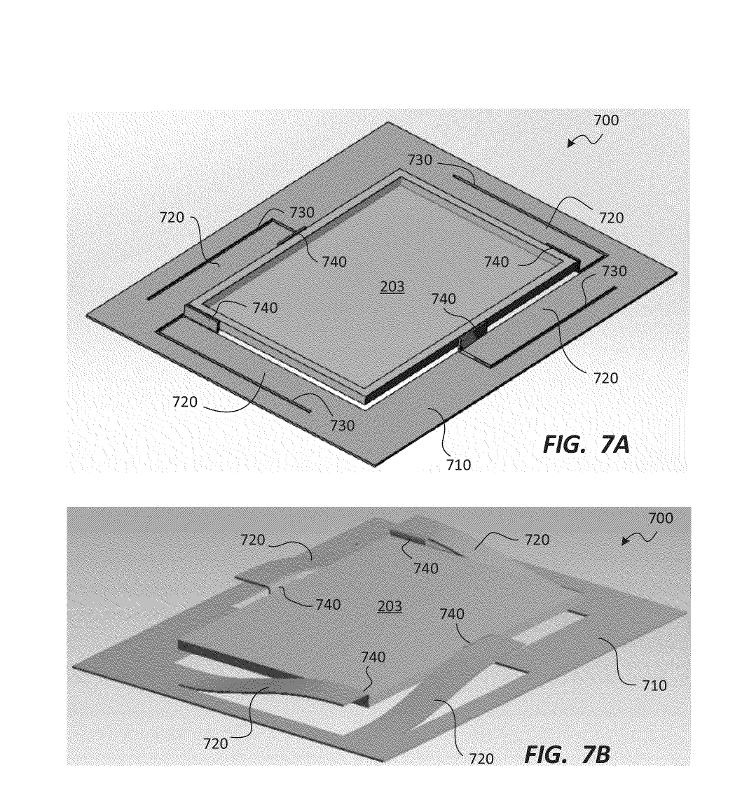

The configurations of FIGS. 4 and 5, and the method of FIG. 6, may be implemented through the use of various hardware structures. More specifically, the actuation assembly 404 of the camera 200 may have any of a wide variety of mechanical components, which may include an actuator that urges relative motion between the microlens array 202 and the image sensor 203, and a guide mechanism that guides the resulting relative motion. Various exemplary actuators and guide mechanisms will be shown and described in connection with FIGS. 7A through 13B, as follows. Additionally or alternatively, any of the actuators and/or guide mechanisms disclosed in U.S. Utility application Ser. No. 14/480,240 for “Light Field Image Capture Device Having 2D Image Capture Mode” (Atty. Docket No. LYT140), which is incorporated herein by reference, may be used.

### Blade Type Flexure Sheets

FIGS. 7A and 7B are perspective views of a guide mechanism in the form of a blade type flexure sheet 700, in a rest configuration and a flexed configuration, respectively, according to one embodiment. The blade type flexure sheet 700 may generally be designed to flex to permit motion of a component captured by the blade type flexure sheet 700. The captured component may be the microlens array 202 or the image sensor 203. As in the example of FIGS. 4 and 5, it will be assumed here that the microlens array 202 is the component that moves, while the image sensor 203 remains stationary relative to the other components of the camera 200. Thus, the captured component will be assumed to be the microlens array 202.

As shown, the blade type flexure sheet 700 may have frame 710, which may be attached to one or more other components of the camera 200, such as to the image sensor 203. The blade type flexure sheet 700 may have a plurality of blades 720 that are defined within the frame 710 by the formation of slits 730 in the frame 710, as shown in FIG. 7A. Each of the blades 720 may have a geometry selected to enable selective bending, in a manner similar to that of a single-end cantilevered beam, relative to the remainder of the frame 710, as illustrated in FIG. 7B. The slits 730 may all be the same length such that the blades 720 are also the same length. Hence, the blades 720 that extend perpendicular to the length of the blade type flexure sheet 700 may extend across the entire interior, and the blades 720 that extend parallel to the length of the blade type flexure sheet 700 may extend along only part of the interior.

Each of the blades 720 may terminate in a tab 740, which may extend generally perpendicular to the frame 710. The outward-facing edges of the microlens array 202 may be secured to the tabs 740 so that the microlens array 202 is fixed relative to the adjoining ends of the blades 720. The side of the frame 710 that faces upward in FIG. 7A may be secured to the image sensor 203. In FIG. 7B, the frame 710 has been turned upside-down relative to the view of FIG. 7A. In the rest configuration of FIG. 7A, the microlens array 202 may reside adjacent to the image sensor 203 to provide the conventional capture configuration. In the flexed configuration of FIG. 7B, the microlens array 202 may be displaced from the image sensor 203 to provide the light-field capture configuration.

The blades 720 may be constrained, by virtue of the geometry of the blade type flexure sheet 700, to bend synchronously with each other so that the microlens array 202 is always kept substantially parallel to the frame 710. Thus, if the frame 710 is secured to the image sensor 203, motion of the microlens array 202 may be constrained by the blade type flexure sheet 700 in a manner that keeps the microlens array 202 substantially parallel to the image sensor 203. Forces tending to bend one or two of the blades 720 may thus tend to also cause bending of the remaining blades 720, thereby keeping the microlens array 202 parallel to the image sensor 203.

The blade type flexure sheet 700 may have a natural bias toward the rest configuration; thus, in the absence of force actuating the blade type flexure sheet 700 into the flexed configuration, the blade type flexure sheet 700 may remain in the rest configuration. An actuator, such as any of the actuators that will be described below, may be used to urge the blade type flexure sheet 700 into the flexed configuration.

When the blade type flexure sheet 700 is secured to the image sensor 203 as indicated above, the rest configuration may be the conventional capture configuration. In alternative embodiments, the blade type flexure sheet 700 may be secured to the image sensor 203 in such a manner that, in the rest configuration, the blade type flexure sheet 700 keeps the microlens array 202 displaced from the image sensor 203 to provide the light-field capture configuration. The flexed configuration of the blade type flexure sheet 700 may then provide the conventional capture configuration.

### Diaphragm Type Flexure Sheets

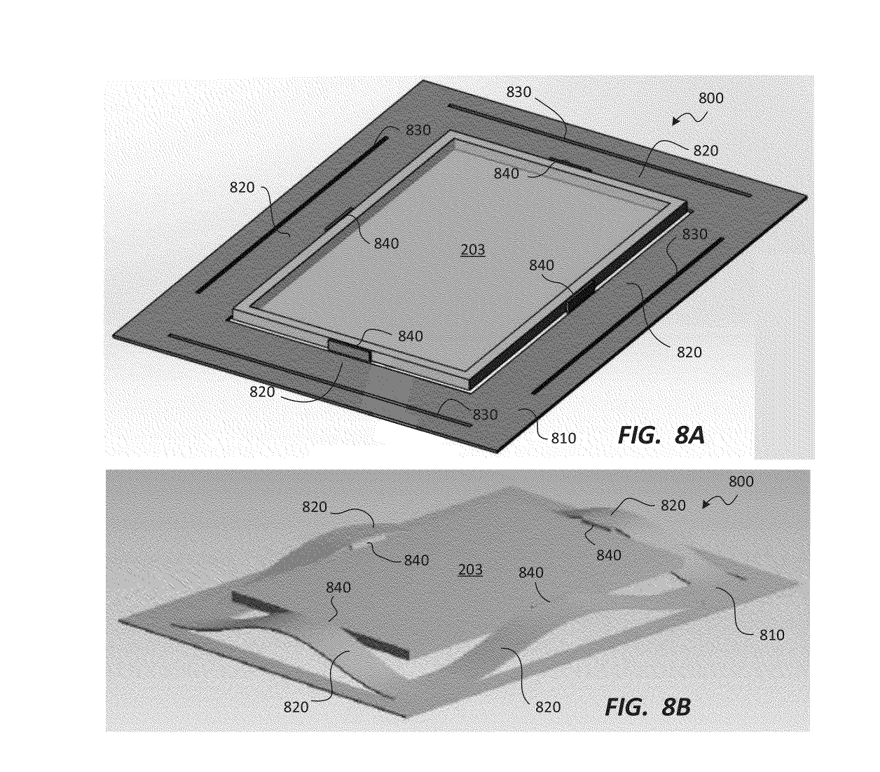

FIGS. 8A and 8B are perspective views of a guide mechanism in the form of a diaphragm type flexure sheet 800, in a rest configuration and a flexed configuration, respectively, according to one embodiment. Like the blade type flexure sheet 700, the diaphragm type flexure sheet 800 may generally be designed to flex to permit motion of a captured component, which will be assumed to be the microlens array 202. The image sensor 203 will again be assumed to remain stationary relative to the other components of the camera 200. However, in alternative embodiments, a diaphragm type flexure sheet may be used in the reverse configuration, i.e., to retain and move the image sensor 203 relative to a microlens array 202, which may remain stationary.

Like the blade type flexure sheet 700, the diaphragm type flexure sheet 800 may have frame 810, which may be attached to one or more other components of the camera 200, such as to the image sensor 203. The diaphragm type flexure sheet 800 may have a plurality of diaphragms 820 that are defined within the frame 810 by the formation of slits 830 in the frame 810, as shown in FIG. 8A. Each of the diaphragms 820 may have a geometry selected to enable selective bending, in a manner similar to that of a double-end cantilevered beam, relative to the remainder of the frame 810, as illustrated in FIG. 8B. The slits 830 may all be the same length such that the diaphragms 820 are also the same length. Hence, the diaphragms 820 that extend perpendicular to the length of the diaphragm type flexure sheet 800 may extend across the entire interior, and the diaphragms 820 that extend parallel to the length of the diaphragm type flexure sheet 800 may extend along only part of the interior.

Each of the diaphragms 820 may have a central portion secured to a tab 840, which may extend generally perpendicular to the frame 810. The outward-facing edges of the microlens array 202 may be secured to the tabs 840 so that the microlens array 202 is fixed relative to the adjoining central portions of the diaphragms 820. The side of the frame 810 that faces upward in FIG. 8A may be secured to the image sensor 203. In FIG. 8B, the frame 810 has been turned upside-down relative to the view of FIG. 8A. In the rest configuration of FIG. 8A, the microlens array 202 may reside adjacent to the image sensor 203 to provide the conventional capture configuration. In the flexed configuration of FIG. 8B, the microlens array 202 may be displaced from the image sensor 203 to provide the light-field capture configuration.

The diaphragms 820 may be constrained, by virtue of the geometry of the diaphragm type flexure sheet 800, to bend synchronously with each other so that the microlens array 202 is always kept substantially parallel to the frame 810. Thus, if the frame 810 is secured to the image sensor 203, motion of the microlens array 202 may be constrained by the diaphragm type flexure sheet 800 in a manner that keeps the microlens array 202 substantially parallel to the image sensor 203. Forces tending to bend one or two of the diaphragms 820 may thus tend to also cause bending of the remaining diaphragms 820, thereby keeping the microlens array 202 parallel to the image sensor 203.

The diaphragm type flexure sheet 800 may have a natural bias toward the rest configuration; thus, in the absence of force actuating the diaphragm type flexure sheet 800 into the flexed configuration, the diaphragm type flexure sheet 800 may remain in the rest configuration. An actuator, such as any of the actuators that will be described below, may be used to urge the diaphragm type flexure sheet 800 into the flexed configuration.

When the diaphragm type flexure sheet 800 is secured to the image sensor 203 as indicated above, the rest configuration may be the conventional capture configuration. In alternative embodiments, the diaphragm type flexure sheet 800 may be secured to the image sensor 203 in such a manner that, in the rest configuration, the diaphragm type flexure sheet 800 keeps the microlens array 202 displaced from the image sensor 203 to provide the light-field capture configuration. The flexed configuration of the diaphragm type flexure sheet 800 may then provide the conventional capture configuration.

By comparison with the blade type flexure sheet 700 of FIGS. 7A and 7B, the diaphragm type flexure sheet 800 may provide similar operation, with a few differences. Notably, the double-end cantilever of the diaphragms 820 may make the diaphragms 820 more resistant to bending than the blades 720. However, the diaphragms 820 may have more predictable motion than the blades 720, with less likelihood of rotating the microlens array 202 relative to the diaphragm type flexure sheet 800 during motion into the flexed configuration. Thus, the diaphragm type flexure sheet 800 may provide smaller motion and/or require greater actuation force, but may provide more stable motion of the microlens array 202 relative to the image sensor 203.

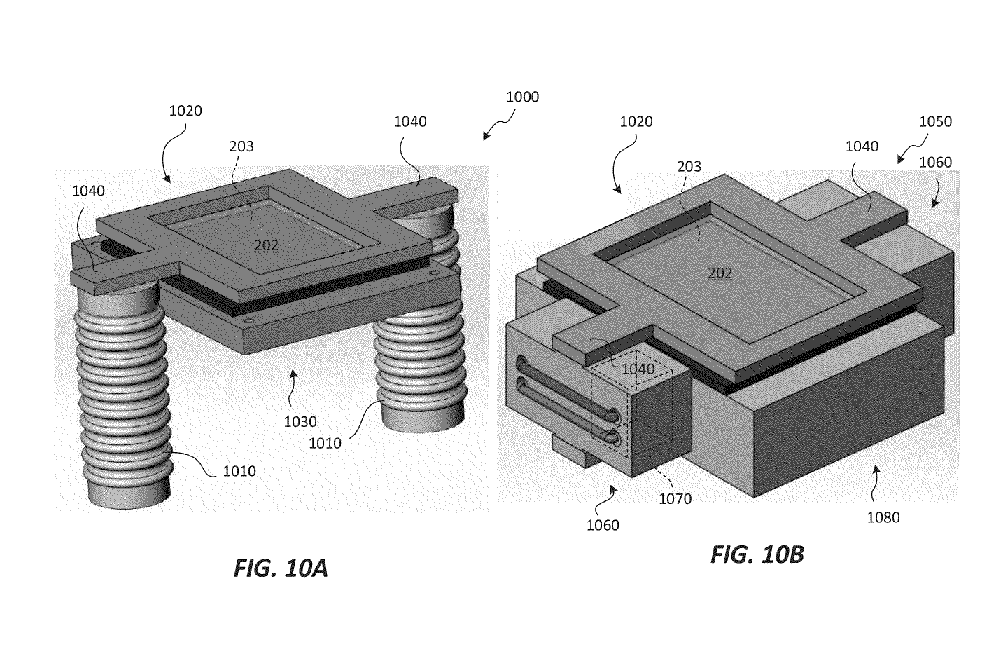

The blade type flexure sheet 700 and the diaphragm type flexure sheet 800 are only two of many guide mechanisms that may be used to guide relative motion between the microlens array 202 and the image sensor 203. In alternative embodiments, other guide mechanisms may be used. Further, in some embodiments, an actuator may provide sufficient motion constraint to operate without requiring the use of a separate guide mechanism. Some such actuators will be shown and described in connection with FIGS. 10A and 10B below.

### Permanent Magnets

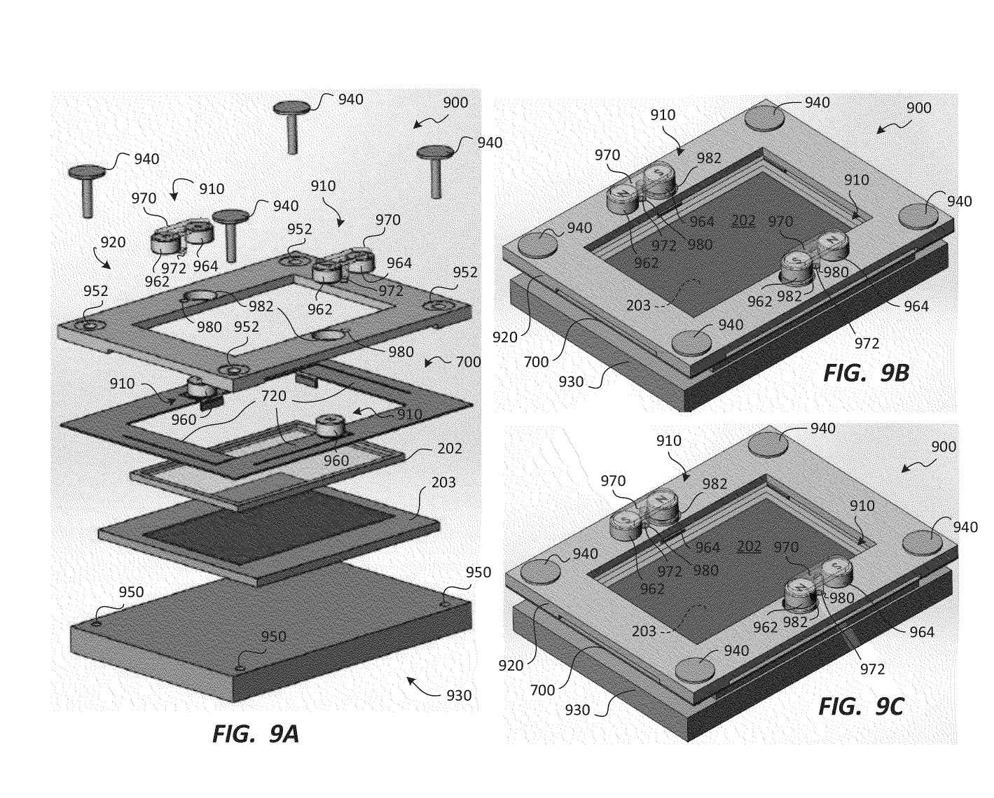

FIGS. 9A, 9B, and 9C are perspective views of an actuation assembly 900 with actuators in the form of permanent magnets 910, in an exploded configuration, a fully-assembled, conventional capture configuration, and a fully-assembled, light-field capture configuration, respectively, according to one embodiment. The actuation assembly 900 may move the microlens array 202 toward or away from the image sensor 203 through the use of the blade type flexure sheet 700 of FIGS. 7A and 7B.

As shown most clearly in FIG. 9A, the actuation assembly 900 may also have a first base portion 920, a second base portion 930, and a plurality of fasteners 940 that hold the first base portion 920 and the second base portion 930 together. The microlens array 202, the image sensor 203, and the blade type flexure sheet 700 may be retained between the first base portion 920 and the second base portion 930. More particularly, the first base portion 920 may have a plurality of holes 950, for example, one at each corner. The second base portion 930 may also have a plurality of holes 952 positioned at the corners of the second base portion 930 such that, when the first base portion 920 and the second base portion 930 are centered relative to each other, the holes 952 are aligned with the holes 950. The fasteners 940 may be inserted through the holes 952 and anchored in the holes 950 to hold the actuation assembly 900 together.

As shown, the permanent magnets 910 may include frame magnets 960 secured to the blade type flexure sheet 700, repelling base magnets 962 coupled to the first base portion 920, and attracting base magnets 964 that are also coupled to the first base portion 920. The frame magnets 960 may be secured to the ends of two of the blades 720 of the blade type flexure sheet 700, proximate the tabs 840 secured to the microlens array 202. Each pair of repelling base magnets 962 and attracting base magnets 964 may be secured together via a brace 970. Each brace 970 may be rotatably coupled to the first base portion 920 via a post 972.

Specifically, the first base portion 920 may have a recess 980 positioned to receive the distal end of each of the posts 972. When the distal end of a post 972 is seated in a recess 980, the corresponding assembly including one of the repelling base magnets 962, one of the attracting base magnets 964, one of the braces 970, and the post 972, may be rotatable relative to the first base portion 920, about an axis (not shown) passing through the post 972 and the recess 980.

The first base portion 920 may also have an aperture 982 positioned proximate to, and offset from, each of the recesses 980. Each of the apertures 982 may be aligned with one of the frame magnets 960. One of the repelling base magnets 962 and the attracting base magnets 964 may also be aligned with each of the apertures 982 and with each of the frame magnets 960, in the conventional capture configuration and the light-field capture configuration. The magnet that is aligned with the frame magnet 960 may determine whether the actuation assembly 900 provides the conventional capture configuration or the light-field capture configuration.

More specifically, referring to FIG. 9B, the actuation assembly 900 is shown in the conventional capture configuration. Each of the repelling base magnets 962 may be positioned in alignment with the corresponding one of the frame magnets 960 and the recesses 980. The repelling base magnets 962 may be oriented such that they have the opposite polarity from that of the frame magnets 960. Accordingly, the repelling base magnets 962 may urge the frame magnets 960 away from the first base portion 920, causing the microlens array 202 to abut the image sensor 203.

In order to move the actuation assembly 900 to the light-field capture assembly, each magnet assembly, consisting of one of the repelling base magnets 962, one of the attracting base magnets 964, one of the braces 970, and one of the posts 972 may be rotated relative to the recess 980 to which it is rotatably coupled. This rotation may be caused by an electric motor, an electromagnet, or any other rotational actuator (not shown). A gearing system, chain system, or other motion transmitting assembly (not shown) may be used to ensure that the magnet assemblies rotate in synchronization with each other.

This rotation may cause the repelling base magnets 962 to be rotated out of alignment with the recesses 980 and the frame magnets 960. When the magnet assemblies are rotated a full 180°, the attracting base magnets 964 may be aligned with the recesses 980 and the frame magnets 960. This is the configuration shown in FIG. 9C.

Referring to FIG. 9C, the actuation assembly 900 is shown in the light-field capture configuration. Each of the attracting base magnets 964 may be positioned in alignment with the corresponding one of the frame magnets 960 and the recesses 980. The attracting base magnets 964 may be oriented such that they have the same polarity as that of the frame magnets 960. Accordingly, the attracting base magnets 964 may urge the frame magnets 960 toward the first base portion 920, causing the microlens array 202 to move away from the image sensor 203. The first base portion 920 and the second base portion 930 may cooperate to provide motion stops such that the microlens array 202 is unable to move further from the image sensor 203 than the displacement 403, which may be at or near the optimal displacement for capturing light-field images.

The use of two magnet assemblies is merely exemplary. In other embodiments, more or fewer magnet assemblies may be used. For example, in some embodiments, only one of the frame magnets 960, one of the repelling base magnets 962, and one of the attracting base magnets 964 may be used. The manner in which the blade type flexure sheet 700 flexes may help cause the microlens array 202 to remain parallel to the image sensor 203, even if actuation force is applied only to one side of the blade type flexure sheet 700.

In alternative embodiments, four of the frame magnets 960, four of the repelling base magnets 962, and four of the attracting base magnets 964 may be used. One of the frame magnets 960 may be positioned at the end of all four of the blades 720, and four pairs of the repelling base magnets 962 and the attracting base magnets 964 may be rotatably coupled to the first base portion 920, in selective alignment with the frame magnets 960. Usage of a larger number of the permanent magnets 910 may cause actuation to occur with greater force, greater speed, and/or enhanced maintenance of alignment between the microlens array 202 and the image sensor 203, but may require greater complexity in construction and/or operation.

There are numerous other ways in which permanent magnets may be used to cause actuation of an actuation assembly to induce relative motion between the microlens array 202 and the image sensor 203. Permanent magnets may have a wide variety of shapes, sizes, and polarities, and may thus be arranged and moved in various ways to cause the desired actuation.

### Piezo Actuators

FIGS. 10A and 10B are perspective views of an actuation assembly 1000 and an actuation assembly 1050 with actuators in the form of piezo actuators and piezo actuators with mechanical amplifiers, respectively, according to selected embodiments. A piezo actuator may provide motion with sufficient reliability and rigidity to obviate the need for a discrete guide mechanism. Accordingly, the actuation assemblies 1000 and 1050 may be examples of embodiments in which the actuator performs both the actuating and guiding functions.

FIG. 10A illustrates an embodiment in which two piezo actuators 1010 are used to move the microlens array 202 relative to the image sensor 203. The piezo actuators 1010 may use piezoelectric crystals, which may expand and/or contract in response to the presence or absence of electric current passing through the piezoelectric crystals. Thus the piezo actuators 1010 may be made to elongate or contract, depending on the presence of electrical input.

The actuation assembly 1000 may also include a first base portion 1020 and a second base portion 1030, between which the microlens array 202 and the image sensor 203 are positioned. The microlens array 202 may be secured to the first base portion 1020, and the image sensor 203 may be secured to the second base portion 1030. The first base portion 1020, or more specifically, wings 1040 extending form the remainder of the first base portion 1020, may be secured to the distal ends of the piezo actuators 1010. The second base portion 1030 may be secured to a fixture (not shown) to which the proximal ends of the piezo actuators 1010 are also attached. Thus, elongation or contraction of the piezo actuators 1010 may cause the microlens array 202 to move further from or closer to the image sensor 203, respectively.

As indicated previously, no separate guide mechanism may be needed. Accordingly, inclusion of the blade type flexure sheet 700, the diaphragm type flexure sheet 800, and/or any other guide mechanism is optional. The rigidity of the piezo actuators 1010 may rather provide a sufficient guiding function independently of the use of a separate guiding mechanism.

In order to achieve the desired displacement between the microlens array 202 and the image sensor 203 for capturing light-field images (for example, μM as mentioned previously), the piezo actuators 1010 may be somewhat longer than the depth of the first base portion 1020, the second base portion 1030, and the intervening components. Accordingly, in some embodiments, it may be desirable to use a piezo actuator with which the same motion can be obtained with a shorter length.

FIG. 10B illustrates an embodiment in which two piezo actuators 1060 with mechanical amplification are used to move the microlens array 202 relative to the image sensor 203. The piezo actuators 1060 may also use piezoelectric crystals operating via expansion or contraction, as in the piezo actuators 1010 of the previous embodiment. However, the piezo actuators 1060 may accomplish the same motion (for example, 38 μM as mentioned previously) with a shorter length. This may be accomplished by including mechanical amplifiers 1070 in the piezo actuators 1060. The mechanical amplifiers 1070 may cause the ultimate elongation or contraction of the piezo actuators 1060 to be greater than that of the piezoelectric crystals by a factor of more than one (for example, 1.5, 2, 2.5, or 3).

The actuation assemblies 1050 may have a first base portion 1020 like that of the actuation assembly 1000, and a second base portion 1080 with a larger depth so that the proximal ends of the second base portion 1080 and the piezo actuators 1060 can be anchored to a common plate or other structure (not shown). The overall size of the actuation assembly 1050 may be smaller than that of the actuation assembly 1000, which may facilitate inclusion of the actuation assembly 1050 in the space available within the camera 200.

### Solenoids

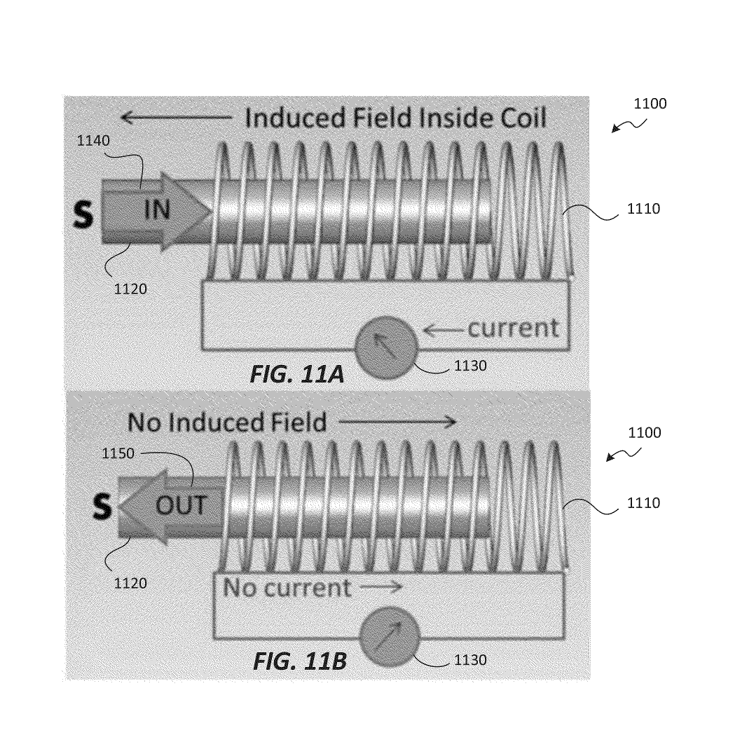

FIGS. 11A and 11B are side elevation views of an actuator in the form of a solenoid 1100, with current flow to urge retraction of the solenoid, and with no current flow, according to one embodiment. The solenoid may have a coil 1110 and a core 1120 that is movable within the coil 1110. The coil 1110 may be connected to a current source 1130. The core 1120 may be a permanent magnet, or may be a magnetic material such as a ferritic material that is readily movable in response to exposure to a magnetic field.

As illustrated in FIG. 11A, in a first configuration, the current source 1130 may supply a current through the coil 1110 that produces a magnetic field in the coil 1110. The magnetic field may urge the core 1120 to move relative to the coil 1110, for example, to the right, as indicated by the arrow 1140.

As illustrated in FIG. 11B, in a second configuration, the current source 1130 may not supply the current through the coil 1110. Thus, no magnetic field may be produced in the coil 1110. The lack of a magnetic field may allow the core 1120 to move relative to the coil 1110, for example, to the left, as indicated by the arrow 1150. If desired, a spring or other device may be used to cause the core 1120 to move leftward in the absence of a stronger force, such as the force induced by the magnetic field, inducing the core 1120 to move rightward.

The solenoid 1100 may be connected to a guide mechanism such as the blade type flexure sheet 700 of FIG. 7 or the diaphragm type flexure sheet 800 of FIG. 8 to define an actuation assembly. Additionally or alternatively, the solenoid 1100 may be capable of moving the microlens array 202 relative to the image sensor 203 without requiring the use of a guide mechanism. The solenoid 1100 may be connected to provide the light-field capture configuration when positioned as in FIG. 11A, and the conventional capture configuration when positioned as in FIG. 11B. In the alternative, the solenoid 1100 may be connected to provide the conventional capture configuration when positioned as in FIG. 11A, and the light-field capture configuration when positioned as in FIG. 11B.

### Voice Coil Actuators

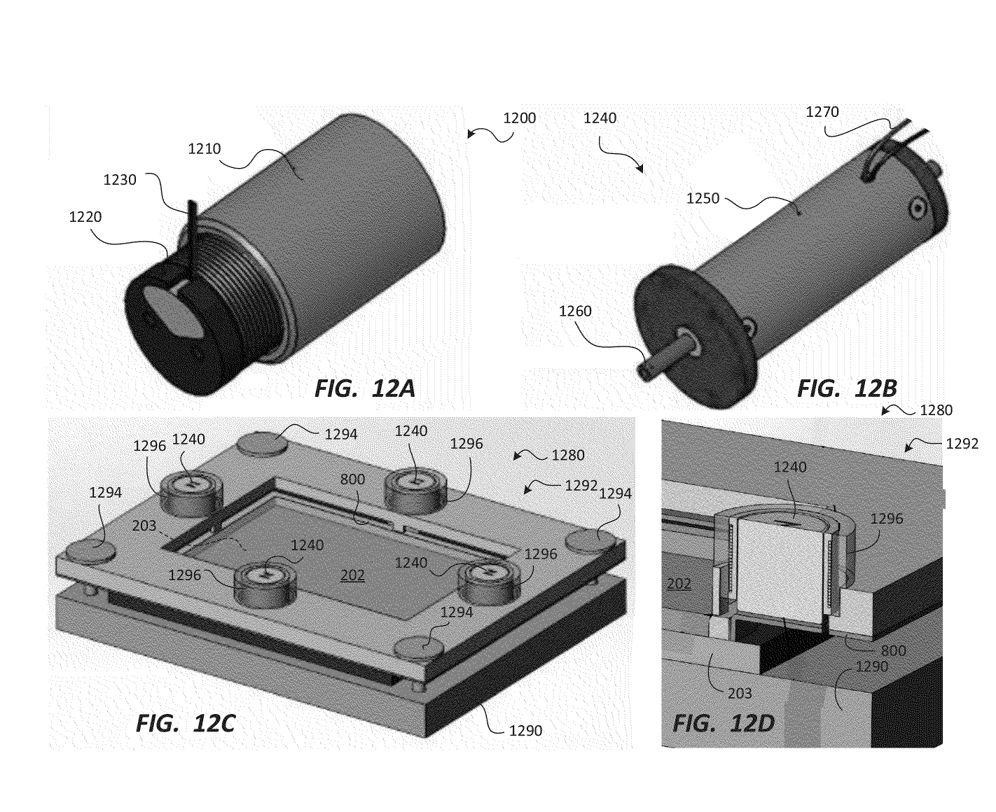

FIGS. 12A and 12B are perspective views of a moving coil voice coil actuator 1200 and a moving magnet voice coil actuator 1240, according to selected embodiments. The moving coil voice coil actuator 1200 and the moving magnet voice coil actuator 1240 may be with or without a guide mechanism, such as the blade type flexure sheet 700 and/or the diaphragm type flexure sheet 800, to define an actuation assembly, as described in connection with the actuators of previous embodiments.

As shown in FIG. 12A, the moving coil voice coil actuator 1200 may have a housing 1210 and a coil 1220 that moves relative to the housing 1210. A core (not shown) may reside within the housing 1210, and may be stationary relative to the housing 1210. When current is applied to the coil 1220 through power leads 1230, a magnetic field may be generated via flow of the current through the coil 1220. The magnetic field may attract and/or repel the coil 1220 relative to the core to cause the coil 1220 to move out of the housing 1210, or to retract into the housing 1210.

The moving coil voice coil actuator 1200 may be connected to the microlens array 202 and the image sensor 203 such that extension of the coil 1220 from the housing 1210 provides the light-field capture configuration, and retraction of the coil 1220 into the housing 1210 provides the conventional capture configuration. In the alternative, retraction of the coil 1220 into the housing 1210 may provide the light-field capture configuration, and extension of the coil 1220 from the housing 1210 may provide the conventional capture configuration.

As shown in FIG. 12B, the moving magnet voice coil actuator 1240 may have a housing 1250 and a magnetic core 1260 that moves relative to the housing 1250. A coil (not shown) may reside within the housing 1250, and may be stationary relative to the housing 1250. When current is applied to the coil through power leads 1270, a magnetic field may be generated via flow of the current through the coil. The magnetic field may attract and/or repel the magnetic core 1260 relative to the coil to cause the magnetic core 1260 to move out of the housing 1250, or to retract into the housing 1250.

The moving magnet voice coil actuator 1240 may be connected to the microlens array 202 and the image sensor 203 such that extension of the magnetic core 1260 from the housing 1250 provides the light-field capture configuration, and retraction of the magnetic core 1260 into the housing 1250 provides the conventional capture configuration. In the alternative, retraction of the magnetic core 1260 into the housing 1250 may provide the light-field capture configuration, and extension of the magnetic core 1260 from the housing 1250 may provide the conventional capture configuration.

FIGS. 12C and 12D are perspective and section views, respectively, of an actuation assembly 1280 with actuators in the form of moving magnet voice coil actuators 1240 as in FIG. 12B, according to one embodiment. The actuation assembly 1280 may have a structure similar to that of the actuation assembly 900 of FIGS. 9A through 9C, but with the moving magnet voice coil actuators 1240 used in place of the permanent magnets 910.

Specifically, as shown in FIG. 12C, the actuation assembly 1280 may have a first base portion 1290, a second base portion 1292, and a plurality of fasteners 1294 that hold the first base portion 1290 and the second base portion 1292 together. The microlens array 202, the image sensor 203, and a guide mechanism such as the blade type flexure sheet 700 or the diaphragm type flexure sheet 800 may be retained between the first base portion 1290 and the second base portion 1292. The diaphragm type flexure sheet 800 is illustrated in FIGS. 12C and 12D by way of example.

As shown, the second base portion 1292 may have a plurality of receptacles 1296 that protrude above the planar surface of the second base portion 1292 to retain the moving magnet voice coil actuators 1240. The manner in which the moving magnet voice coil actuators 1240 are retained in the receptacles 1296 is shown in more detail in connection with FIG. 12D.

As shown in FIG. 12D, each of the moving magnet voice coil actuators 1240 may be received in one of the receptacles 1296 such that the housing 1250 of the moving magnet voice coil actuator 1240 is secured to the interior of the receptacle 1296. The magnetic core 1260 may be oriented to extend from the housing 1250 toward the diaphragm type flexure sheet 800.

When retracted into the housing 1250, the magnetic core 1260 may dispose the diaphragm type flexure sheet 800 in the flexed configuration, as shown in FIG. 8B, such that the microlens array 202 is displaced from the image sensor 203 to provide the light-field capture configuration. When extended from the housing 1250, the magnetic core 1260 may dispose the diaphragm type flexure sheet 800 in the rest configuration, as shown in FIG. 8A, such that the microlens array 202 abuts the image sensor 203 to provide the conventional capture configuration.

FIG. 12C illustrates the presence of four of the moving magnet voice coil actuators 1240 arranged at the center of each side of the actuation assembly 1280. However as indicated in connection with the permanent magnets 910 of FIGS. 9A through 9C, any number of the moving magnet voice coil actuators 1240 may be used, and they may be arranged in any pattern. Such arrangements may include asymmetrical arrangements of one or more of the moving magnet voice coil actuators 1240 about the perimeter of the blade type flexure sheet 700 or the diaphragm type flexure sheet 800. The blade type flexure sheet 700 or the diaphragm type flexure sheet 800 may tend to retain parallelism between the microlens array 202 and the image sensor 203 in spite of the presence of asymmetrical actuation force.

### Bimetallic Strips

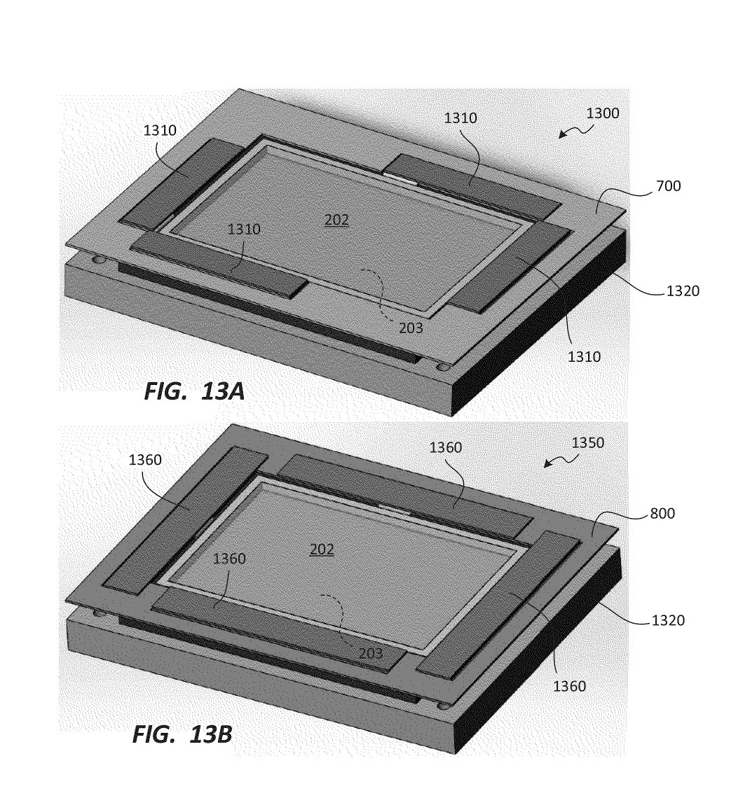

FIGS. 13A and 13B are perspective views of an actuation assembly 1300 with actuators in the form of blade type bimetallic strips 1310 and an actuation assembly 1350 with actuators in the form of diaphragm type bimetallic strips 1360, respectively, according to selected embodiments. The actuation assembly 1300 may include the blade type flexure sheet 700 of FIG. 7, which may be used in conjunction with the blade type bimetallic strips 1310. Similarly, the actuation assembly 1350 may include the diaphragm type flexure sheet 800 of FIG. 8, which may be used in conjunction with the diaphragm type bimetallic strips 1360.

More precisely, referring to FIG. 13A, the actuation assembly 1300 may include a first base portion 1320, a second base portion (not shown), and a plurality of fasteners (not shown) that hold the first base portion 1320 and the second base portion together. The microlens array 202, the image sensor 203, and the blade type flexure sheet 700 may be retained between the first base portion 1320 and the second base portion.

The blade type bimetallic strips 1310 may each have a first surface (for example, the surface facing the blade type flexure sheet 700, which is not visible in FIG. 13A) formed of a first material, such as a first metal, with a first coefficient of thermal expansion. Further, the blade type bimetallic strips 1310 may each have a second surface (for example, the exposed, upward-facing surface of FIG. 13A) formed of a second material, such as a second metal, with a second coefficient of thermal expansion that is less than the first coefficient of thermal expansion. The differential between coefficients of thermal expansion may mean that, when exposed to a common temperature differential (for example, when heated to the same temperature), the first surface may expand more than the second surface, leading the blade type bimetallic strips 1310 to curve.

The blade type bimetallic strips 1310 may be welded, brazed, chemically bonded, adhesive bonded, or otherwise attached to the blades 720 of the blade type flexure sheet 700. In the alternative, the blade type bimetallic strips 1310 may be integrated into the blade type flexure sheet 700, for example, by forming the blade type flexure sheet 700 of the first material, and then coating the blades 720 of the blade type flexure sheet 700 with the second material.

When the blade type bimetallic strips 1310 are at room temperature, both sides may be substantially undeflected as shown in FIG. 13A. This may dispose the microlens array 202 in abutment with the image sensor 203, thereby providing the conventional capture configuration. Conversely, when heat is applied to the blade type bimetallic strips 1310, for example, through the use of one or more resistive heating elements (not shown), the blade type bimetallic strips 1310 may deflect to urge the microlens array 202 to move away from the image sensor 203, thereby providing the light-field capture configuration.

Referring to FIG. 13B, the actuation assembly 1350 may include a first base portion 1320 like that of the actuation assembly 1300, a second base portion (not shown), and a plurality of fasteners (not shown) that hold the first base portion 1320 and the second base portion together. The microlens array 202, the image sensor 203, and the diaphragm type flexure sheet 800 may be retained between the first base portion 1320 and the second base portion.

The diaphragm type bimetallic strips 1360 may each have a first surface (for example, the exposed, upward-facing surface of FIG. 13B) formed of a first material, such as a first metal, with a first coefficient of thermal expansion. Further, the diaphragm type bimetallic strips 1360 may each have a second surface (for example, the surface facing the diaphragm type flexure sheet 800, which is not visible in FIG. 13A) formed of a second material, such as a second metal, with a second coefficient of thermal expansion that is less than the first coefficient of thermal expansion. The differential between coefficients of thermal expansion may mean that, when exposed to a common temperature differential (for example, when heated to the same temperature), the first surface may expand more than the second surface, leading the diaphragm type bimetallic strips 1360 to curve.

The diaphragm type bimetallic strips 1360 may be welded, brazed, chemically bonded, adhesive bonded, or otherwise attached to the diaphragms 820 of the diaphragm type flexure sheet 800. In the alternative, the diaphragm type bimetallic strips 1360 may be integrated into the diaphragm type flexure sheet 800, for example, by forming the diaphragm type flexure sheet 800 of the first material, and then coating the diaphragms 820 of the diaphragm type flexure sheet 800 with the second material.

When the diaphragm type bimetallic strips 1360 are at room temperature, both sides may be substantially undeflected as shown in FIG. 13A. This may dispose the microlens array 202 in abutment with the image sensor 203, thereby providing the conventional capture configuration. Conversely, when heat is applied to the diaphragm type bimetallic strips 1360, for example, through the use of one or more resistive heating elements (not shown), the diaphragm type bimetallic strips 1360 may deflect to urge the microlens array 202 to move away from the image sensor 203, thereby providing the light-field capture configuration.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A method for capturing an image through use of a light-field camera, the method comprising:
at an input device of the light-field camera, receiving user input;
in response to receipt of the user input, moving the light-field camera from an initial configuration comprising a selection from the group consisting of a light-field capture configuration and a conventional capture configuration, to a selected configuration comprising the other of the group consisting of the light-field capture configuration and the conventional capture configuration; and
at a sensor of the light-field camera, with the light-field camera in the selected configuration, capturing a first image.

2. The method of claim 1, further comprising, prior to receiving the user input and with the light-field camera in the initial configuration, capturing a second image;
wherein one of the first image and the second image comprises a light-field image;
and wherein the other of the first image and the second image comprises a conventional image.

3. The method of claim 1, wherein the light-field camera comprises an aperture, a main lens, and a microlens array;
wherein the sensor is positioned proximate the microlens array to capture light after passage of the light through the main lens and the microlens array;
and wherein moving the light-field camera from the initial configuration to the selected configuration comprises inducing relative motion between the microlens array and the sensor between a light-field displacement, at which the microlens array is displaced from the sensor to cause the light to define a light-field image, and a conventional displacement, at which the microlens array is positioned closer to the sensor to cause the light to define a conventional image.

4. The method of claim 3, wherein the light-field displacement is about 38 μM, and wherein the conventional displacement is about 0 μM such that, in the conventional capture configuration, the microlens array is positioned to abut the sensor.

5. The method of claim 3, wherein the light-field camera further comprises a guide mechanism and an actuator;
wherein moving the light-field camera from the initial configuration to the selected configuration comprises:
with the actuator, urging relative motion between the microlens array and the sensor to induce motion toward one of the light-field capture configuration and the conventional capture configuration; and
with the guide mechanism, guiding the relative motion.

6. The method of claim 5, wherein the actuator comprises a plurality of permanent magnets;
wherein moving the light-field camera from the initial configuration to the selected configuration comprises moving the permanent magnets.

7. The method of claim 5, wherein the actuator and the guide mechanism are integrated in a piezo actuator;
wherein moving the light-field camera from the initial configuration to the selected configuration comprises altering voltage input to the piezo actuator to cause one of elongation and contraction of the piezo actuator.

8. The method of claim 7, wherein the actuator further comprises a mechanical amplifier;
wherein moving the light-field camera from the initial configuration to the selected configuration comprises mechanically amplifying motion of the piezo actuator with the mechanical amplifier.

9. The method of claim 5, wherein the actuator comprises a solenoid comprising a coil and a core;
wherein moving the light-field camera from the initial configuration to the selected configuration comprises altering a flow of electric current through the coil to urge the core to move relative to the coil.

10. The method of claim 5, wherein the actuator comprises a moving coil type voice coil comprising a coil and a permanent magnet;
wherein moving the light-field camera from the initial configuration to the selected configuration comprises altering current flow through the coil to urge the coil to move relative to the permanent magnet.

11. The method of claim 5, wherein the actuator comprises a moving magnet type voice coil comprising a coil and a permanent magnet;
wherein moving the light-field camera from the initial configuration to the selected configuration comprises altering current flow through the coil to urge the permanent magnet to move relative to the coil.

12. The method of claim 5, wherein the actuator comprises a bimetallic strip comprising a first side formed of a first material having a first coefficient of thermal expansion and a second side formed of a second material having a second coefficient of thermal expansion less than the first coefficient of thermal expansion;
wherein moving the light-field camera from the initial configuration to the selected configuration comprises inducing heating the bimetallic strip to cause the first side to expand more than the second side, thereby urging a central portion of the first side to move relative to ends of the first side.

13. The method of claim 5, wherein the guide mechanism comprises a flexure sheet secured to one of the sensor and the microlens array;
wherein moving the light-field camera from the initial configuration to the selected configuration comprises one of increasing flexure in the flexure sheet, and relieving flexure in the flexure sheet.

14. A light-field camera for capturing an image, the light-field camera comprising:
an input device configured to receive user input;
an actuation assembly configured, in response to receipt of the user input, to move the light-field camera from an initial configuration comprising a selection from the group consisting of a light-field capture configuration and a conventional capture configuration, to a selected configuration comprising the other of the group consisting of the light-field capture configuration and the conventional capture configuration; and
a sensor configured, with the light-field camera in the selected configuration, to capture a first image.

15. The light-field camera of claim 14, wherein the sensor is further configured, prior to receiving the user input and with the light-field camera in the initial configuration, to capture a second image;
wherein one of the first image and the second image comprises a light-field image;
and wherein the other of the first image and the second image comprises a conventional image.

16. The light-field camera of claim 14, further comprising an aperture, a main lens, and a microlens array;
wherein the sensor is positioned proximate the microlens array to capture light after passage of the light through the main lens and the microlens array;
and wherein the actuation assembly is further configured to move the light-field camera from the initial configuration to the selected configuration by inducing relative motion between the microlens array and the sensor between a light-field displacement, at which the microlens array is displaced from the sensor to cause the light to define a light-field image, and a conventional displacement, at which the microlens array is positioned closer to the sensor to cause the light to define a conventional image.

17. The light-field camera of claim 16, wherein the light-field displacement is about 38 μM, and wherein the conventional displacement is about 0 μM such that, in the conventional capture configuration, the microlens array is positioned to abut the sensor.

18. The light-field camera of claim 16, wherein the actuation assembly comprises a guide mechanism and an actuator;
wherein the actuator is configured to urge relative motion between the microlens array and the sensor to induce motion toward one of the light-field capture configuration and the conventional capture configuration;
and wherein the guide mechanism is configured to guide the relative motion.

19. The light-field camera of claim 18, wherein the actuator comprises a plurality of permanent magnets configured to move to urge the light-field camera to move from the initial configuration to the selected configuration.

20. The light-field camera of claim 18, wherein the actuator and the guide mechanism are integrated in a piezo actuator configured to urge the light-field camera to move from the initial configuration to the selected configuration in response to alteration in voltage input to the piezo actuator that causes one of elongation and contraction of the piezo actuator.

21. The light-field camera of claim 20, wherein the actuator further comprises a mechanical amplifier configured to mechanically amplify motion of the piezo actuator.

22. The light-field camera of claim 18, wherein the actuator comprises a solenoid comprising a coil and a core;
wherein the solenoid is configured, in response to alteration in a flow of electric current through the coil, to urge the core to move relative to the coil.

23. The light-field camera of claim 18, wherein the actuator comprises a moving coil type voice coil comprising a coil and a permanent magnet;
wherein the moving coil type voice coil is configured, in response to alteration of current flow through the coil, to urge the coil to move relative to the permanent magnet.

24. The light-field camera of claim 18, wherein the actuator comprises a moving magnet type voice coil comprising a coil and a permanent magnet;
wherein the moving magnet type voice coil is configured, in response to alteration of current flow through the coil, to urge the permanent magnet to move relative to the coil.

25. The light-field camera of claim 18, wherein the actuator comprises a bimetallic strip comprising a first side formed of a first material having a first coefficient of thermal expansion and a second side formed of a second material having a second coefficient of thermal expansion less than the first coefficient of thermal expansion;
wherein the bimetallic strip is configured, in response to heating of the bimetallic strip, to cause the first side to expand more than the second side, thereby urging a central portion of the first side to move relative to ends of the first side.

26. The light-field camera of claim 18, wherein the guide mechanism comprises a flexure sheet secured to one of the sensor and the microlens array;
wherein the flexure sheet is configured such that motion of the light-field camera from the initial configuration to the selected configuration comprises one of increasing flexure in the flexure sheet, and relieving flexure in the flexure sheet.
